(19) United States
(12) Patent Application Publication
(10) Pub. No.: US 2017/0205645 A1
(43) Pub. Date: Jul. 20, 2017

(54) DISPLAY APPARATUS

(71) Applicant: Samsung Electronics Co., Ltd., Suwon-si (KR)

(72) Inventors: Ki Hyung KANG, Suwon-si (KR); Jeong Ho Lee, Suwon-si (KR); Bortnichenko Maria, Suwon-si (KR); Kwak Sik Min, Gunpo-si (KR); Wook-Jae Jeon, Hwaseong-si (KR)

(73) Assignee: Samsung Electronics Co., Ltd., Suwon-si (KR)

(21) Appl. No.: 15/404,696

(22) Filed: Jan. 12, 2017

(30) Foreign Application Priority Data
Jan. 20, 2016 (KR) 10-2016-0006928

(51) Int. Cl. G02F 1/1334; G02F 1/1335; G02F 1/1333; G02F 1/1343

(52) U.S. Cl. CPC G02F 1/1334; G02F 1/134363; G02F 1/133528; G02F 1/134309; G02F 1/133514; G02F 1/133345; G02F 2001/134372; G02F 2201/123; G02F 2001/133531; G02F 2201/121; G02F 2201/50; G02F 2201/122

(57) ABSTRACT

A display apparatus having a backlight unit and a display panel is disclosed. The display panel includes: a first electrode unit having a common electrode; a second electrode unit having a different polarity from the first electrode unit, and configured to include a plurality of pixel electrodes each forming an electric field using electric force of the first electrode unit; an insulator disposed between the first electrode unit and the second electrode unit so as to achieve electric insulation between the first electrode unit and the second electrode unit; and a liquid crystal unit located adjacent to the insulator in a manner that several pixel electrodes of the second electrode unit are inserted in the liquid crystal unit. The length or height of the pixel electrodes of the second electrode unit is ⅓ or higher of the length or height of the liquid crystal unit.

### CROSS-REFERENCE TO RELATED APPLICATIONS

This application claims the benefit of Korean Patent Application No. 2016-0006928, filed on Jan. 20, 2016 in the Korean Intellectual Property Office, the disclosure of which is incorporated herein by reference.

### BACKGROUND

1. Field

Embodiments of the present disclosure relate to a display apparatus for improving brightness.

2. Description of the Related Art

A display apparatus displays visual and stereoscopic image information.

Representative examples of such display apparatuses include a liquid crystal unit display (LCD), an electroluminescent display (ELD), a field emission display (FED), a plasma display panel (PDP), a thin film transistor liquid crystal unit display device (TFT-LCD), and a flexible display.

For example, the display apparatus has been widely used as a television, a computer monitor, and a laptop monitor. In addition, a display of a mobile terminal, a display of a refrigerator, a display of a camera, etc. have been widely used as displays of various electronic devices.

As described above, display devices for conveying information to a human being have been rapidly developed from typical display devices for displaying only letters and images to the latest display devices for displaying more precise and beautiful images.

### SUMMARY

Additional aspects and/or advantages will be set forth in part in the description which follows and, in part, will be apparent from the description, or may be learned by practice thereof.

Therefore, it is an aspect of the present disclosure to provide a display apparatus including a second electrode unit in which several pixel electrodes, each of which is inserted into a liquid crystal unit and has a height corresponding to ⅓ or higher of the height of the liquid crystal unit, are provided.

It is another aspect of the present disclosure to provide a display apparatus including a second electrode unit, which is arranged in a liquid crystal unit and each pixel electrode is larger in width than the spacing between pixel electrodes.

It is another aspect of the present disclosure to provide a display apparatus in which an electric flux generated in the vicinity of a pixel electrode from among electric fluxes of an electric field formed between a common electrode and a plurality of pixel electrodes is generated parallel to the surface of a substrate.

Additional aspects of the embodiments will be set forth in part in the description which follows and, in part, will be obvious from the description, or may be learned by practice of the embodiments.

In accordance with one aspect of the present disclosure, a display apparatus having a backlight unit and a display panel is disclosed. The display panel includes: a first electrode unit having a common electrode; a second electrode unit having a different polarity from the first electrode unit, and configured to include a plurality of pixel electrodes each forming an electric field using electric force of the first electrode unit; an insulator disposed between the first electrode unit and the second electrode unit so as to achieve electric insulation between the first electrode unit and the second electrode unit; and a liquid crystal unit located adjacent to the insulator in a manner that several pixel electrodes of the second electrode unit are inserted in the liquid crystal unit, wherein a length of the pixel electrodes of the second electrode unit is ⅓ or higher of the length of the liquid crystal unit.

The width of each pixel electrode of the second electrode unit may be less than a distance between neighbor pixel electrodes.

The liquid crystal unit may include: a plurality of liquid crystal unit capsules having liquid crystal unit molecules aligned according to the electric field; and a matrix configured to accommodate the plurality of liquid crystal unit capsules such that the plurality of pixel electrodes are spaced apart from each other by a predetermined distance.

If the electric field is formed in the liquid crystal unit, the liquid crystal unit molecules of the liquid crystal unit may be arranged parallel to the surface of the display panel in a peripheral part of the plurality of pixel electrodes.

The length of the liquid crystal unit may exceed a half a ratio of a wavelength of light incident upon the liquid crystal unit to a bi-refraction value of the liquid crystal unit molecules.

The display panel may further include: a color filter arranged adjacent to the first electrode unit; and a substrate arranged adjacent to the color filter.

The display panel may further include: a first polarization panel configured to transmit light of a first polarization axis from among lights emitted from the backlight unit; and a second polarization panel having a second polarization axis perpendicular to the first polarization axis, and configured to transmit light of the second polarization axis from among lights having passed through the liquid crystal unit.

The display panel may further include: a protective panel disposed between the second polarization panel and the liquid crystal unit so as to protect the liquid crystal unit.

The length or height of the liquid crystal unit may be identical to a length or height between the insulator and the protective panel.

The plurality of pixel electrodes of the second electrode unit may be formed in a three-dimensional (3D) structure protruding from the insulator toward the liquid crystal unit; and a cross-sectional shape of the three-dimensional (3D) structure may be a square shape, a triangular shape, a semi-circular shape, or an oval shape.

In accordance with another aspect of the present disclosure, a display apparatus having a backlight unit and a display panel is disclosed. The display panel includes: a first electrode unit having a common electrode; a second electrode unit having a different polarity from the first electrode unit, and configured to include a plurality of pixel electrodes each forming an electric field using electric force of the first electrode unit; an insulator disposed between the first electrode unit and the second electrode unit so as to achieve electric insulation between the first electrode unit and the second electrode unit; and a liquid crystal unit configured to include not only a plurality of liquid crystal unit capsules, but also a matrix including the plurality of liquid crystal unit capsules and the second electrode unit. The length or height of the plurality of pixel electrodes of the second electrode unit may be equal to or larger than ⅓ of a length or height of the liquid crystal unit, and the width of each pixel electrode of the second electrode unit may be less than a distance between neighbor pixel electrodes.

The liquid crystal unit may be arranged to contact the second electrode unit and the insulator.

If the electric field is formed in the liquid crystal unit, the liquid crystal unit molecules contained in a liquid crystal unit capsule of the liquid crystal unit may be arranged parallel to the surface of the display panel in a peripheral region of the plurality of pixel electrodes.

The first electrode unit and the second electrode unit may be configured to receive electric signals having different polarities.

The plurality of pixel electrodes of the second electrode unit may be formed in a protruding three-dimensional (3D) structure. A cross-sectional shape of the three-dimensional (3D) structure may be a square shape, a triangular shape, a semi-circular shape, or an oval shape.

### BRIEF DESCRIPTION OF THE DRAWINGS

These and/or other aspects of the embodiments will become apparent and more readily appreciated from the following description of the embodiments, taken in conjunction with the accompanying drawings of which:

FIG. 1 is a perspective view illustrating an external appearance of a display apparatus according to an embodiment of the present disclosure.

FIG. 2 is an exploded perspective view illustrating one example of the display apparatus according to an embodiment of the present disclosure.

FIG. 3 is a cross-sectional view illustrating the display apparatus shown in FIG. 2.

FIG. 4 is an exploded perspective view illustrating another example of the display apparatus according to an embodiment of the present disclosure.

FIG. 5 is a cross-sectional view illustrating the display apparatus shown in FIG. 4.

FIG. 6 is a detailed schematic view illustrating a display panel embedded in the display apparatus according to an embodiment of the present disclosure.

FIG. 7A is a view illustrating an example of a liquid crystal unit capsule embedded in the display apparatus according to an embodiment of the present disclosure.

FIG. 7B is a view illustrating that an electric field is applied to the liquid crystal unit capsule shown in FIG. 7A.

FIG. 8 is a view illustrating that an electric field contained in a display panel is formed when a power-supply voltage is applied to the display apparatus according to an embodiment of the present disclosure.

FIG. 9 is a detailed view illustrating the electric field shown in FIG. 8.

FIG. 10A is a view illustrating an example of an optical path within the display panel when a power-supply voltage is not applied to the display apparatus according to an embodiment of the present disclosure.

FIG. 10B is a view illustrating an example of an optical path within the display panel when a power-supply voltage is applied to the display apparatus according to an embodiment of the present disclosure.

FIGS. 11 and 12 illustrate other examples of a second electrode unit embedded in the display apparatus according to an embodiment of the present disclosure.

FIG. 13 is a block diagram illustrating the display apparatus according to an embodiment of the present disclosure.

FIG. 14 is a view illustrating the display panel embedded in the display apparatus according to another embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

The display apparatus according to the embodiments may be implemented as a television, an advertisement panel, an information display panel, etc. The display apparatus may be implemented as a display of a smart phone, a tablet, a laptop, etc., and may also be implemented as a display of various electronic devices.

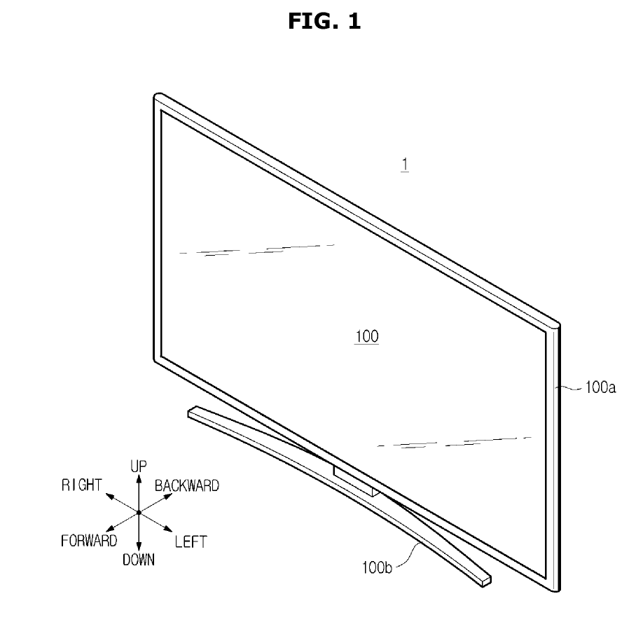

FIG. 1 is a perspective view illustrating an external appearance of a display apparatus according to an embodiment of the present disclosure. For convenience of description and better understanding of the present disclosure, it is assumed that the display apparatus is a television.

The television 1 may be a display apparatus 100 for displaying external broadcast images and stored images, and may include a bezel 100a arranged at the borders.

The display apparatus 100 may be protected from external force by the bezel 100a.

The television 1 may be provided below the display apparatus 100, and may further include a stand 100b for supporting the display apparatus 100.

That is, the display apparatus 100 may remain spaced apart from the ground by a predetermined height by the stand 100b.

The television 1 may further include a bracket (not shown) provided at a rear surface of the display apparatus 100 and to allow fixing to a wall. The display apparatus may be a liquid crystal unit display (LCD), and may form images using light of a direct-type backlight unit or light of an edge-type backlight unit.

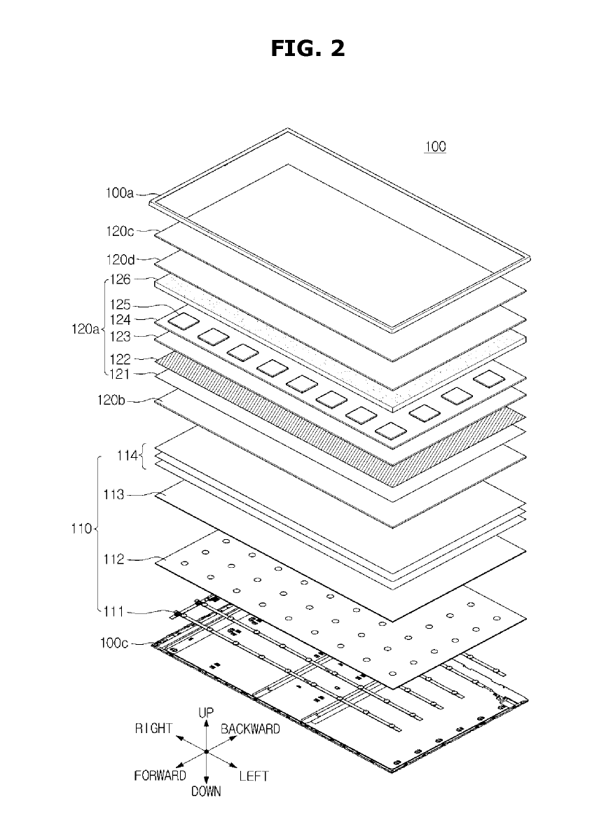

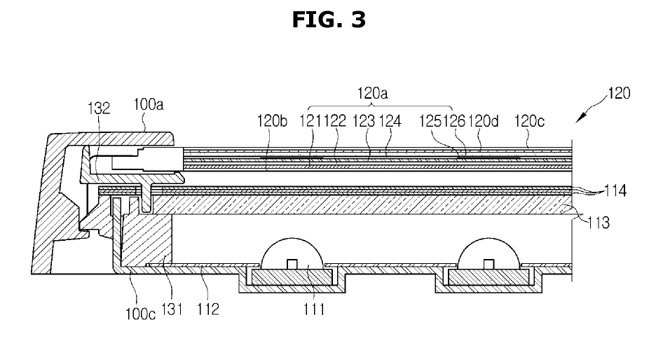

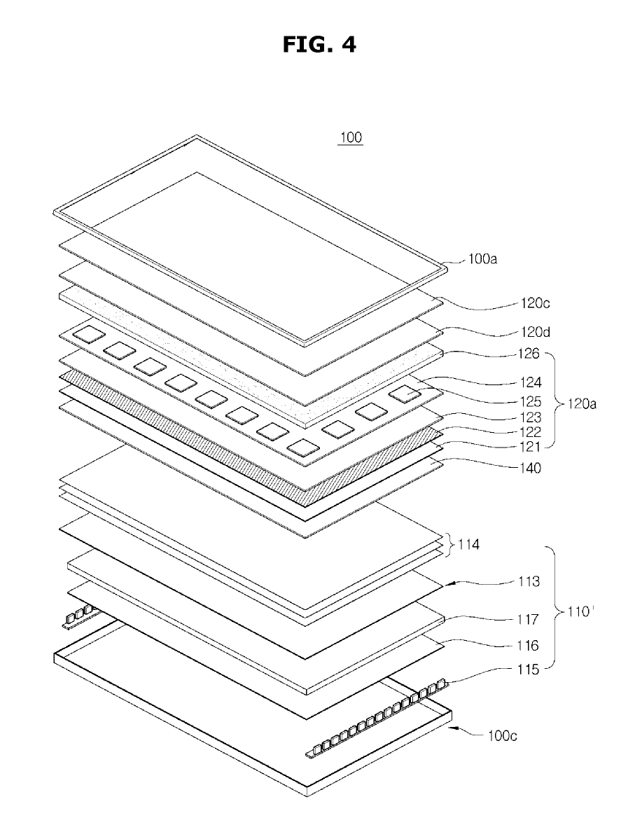

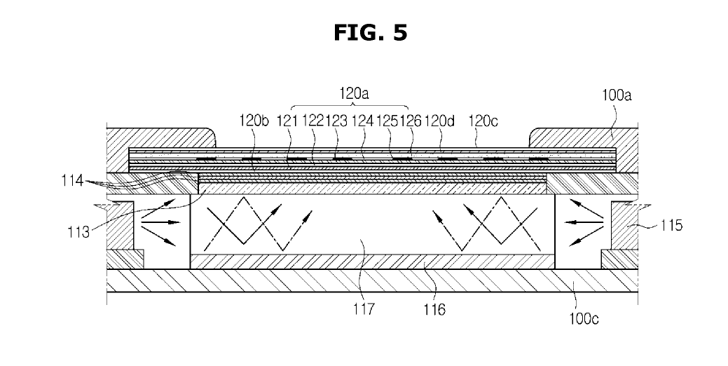

The display apparatus having the direct-type backlight unit will hereinafter be described with reference to FIGS. 2 and 3, and the display apparatus having the edge-type backlight unit will hereinafter be described with reference to FIGS. 4 and 5.

FIGS. 2 and 3 illustrate the display apparatus having the direct-type backlight unit. In more detail, FIG. 2 is an exploded perspective view illustrating the display apparatus having the direct-type backlight unit. FIG. 3 is a cross-sectional view illustrating the display apparatus shown in FIG. 2.

For convenience of description and better understanding of the present disclosure, it is assumed that a direction in which images of the display apparatus 100 are displayed will hereinafter be referred to as a forward direction, and the other direction opposite to the forward direction will hereinafter be referred to as a backward direction on the basis of the position of the display apparatus 100.

Referring to FIGS. 2 and 3, the display apparatus 100 may be coupled to the bezel 100a, and may further include a case 100c located in a rear part thereof so as to form an external appearance of the display apparatus 100.

The display apparatus 100 may include a backlight unit 110 and a display panel 120, which are arranged between the bezel 100a and the case 100c.

In addition, the display apparatus 100 may further include a touch panel (not shown) provided at the front of the display panel 120.

The backlight unit 110 may be disposed between the display panel 120 and the case 100c, may be spaced apart from the display panel 120 by a predetermined distance, and may emit light to the display panel 120.

The backlight unit 110 may include a light emitter 111, a reflective panel 112, a diffusion panel 113, and an optical sheet 114.

The light emitter 111 may be located adjacent to the case 100c, and may emit light to the display panel 120.

The light emitter 111 may include any one of a Cold Cathode Fluorescent Lamp (CCFL), an External Electrode Fluorescent Lamp (EEFL), and a Light Emitting Diode (LED).

The reflective panel 112 may be disposed between the light emitter 111 and the case 100c.

The reflective panel 112 may be arranged at the same surface as the light emitter 111.

In this case, the reflective panel 112 may include a plurality of through-holes in which several light sources of the light emitter 111 are inserted.

That is, several light sources of the light emitting unit 111 are inserted into the through-holes of the reflective panel 111, such that the plurality of light sources may be exposed to the outside.

If some parts of light emitted from the light emitter 111 are incident upon the reflective panel 112, the reflective panel 112 may reflect incident light on the display panel 120.

In this case, some parts of light emitted from the light emitter 111 may be light emitted to the case 100c instead of the display panel, or may be reflected from the diffusion panel 113.

The reflective panel 112 may be manufactured using synthetic resins such as polycarbonate (PC) or polyethylene terephthalate (PET), or may be manufactured using various metal materials.

The diffusion panel 113 may be a translucent or semitransparent panel, which is disposed between the display panel 120 and the light emitter 111 of the backlight unit and diffuses light emitted from the light emitting unit 111 along the surface such that color and brightness of the entire screen of the display panel 120 are uniform, thereby improving brightness of light emitted from the light emitter 111.

The backlight unit 110 may further include one or at least two optical sheets 114.

The optical sheet 114 may equalize brightness of incident light, and may focus diffused light or high-brightness light, such that it can improve light characteristics.

One sheet from among the optical sheets 114 may selectively transmit light of a certain wavelength, and may allow light having a different wavelength to be reflected onto the backlight unit, resulting in increased light transmission efficiency.

The optical sheet may include a prism sheet in which a prism is formed.

The other optical sheet prevents light other than specific-wavelength light from being transmitted, such that the light can be polarized.

The optical sheet may include a Dual Brightness Enhancement Film (DBEF) caused by bi-refraction multi-coating.

The display panel 120 may be disposed in the case 100c, and may be a panel for converting electric information into image information using liquid crystal unit transmission change caused by the applied voltage. The display panel 120 may include a liquid crystal panel 120a, a first polarization panel 120b, a second polarization 120c, and a protective panel 120d.

The liquid crystal panel 120a may include a liquid crystal unit material, and may adjust transmittance of light by changing arrangement of liquid crystal unit, such that different colors are formed according to respective pixels.

By combination of colors of respective pixels formed by the liquid crystal panel 120a, images may be displayed on the display apparatus 100.

The liquid crystal panel 120a may include a substrate 121, a color filter 122, a first electrode unit 123, an insulator 124, a second electrode unit 125, and a liquid crystal unit 126.

In this case, the substrate 121, the color filter 122, the first electrode unit 123, the insulator 124, the second electrode unit 125, and the liquid crystal unit 126 may be sequentially stacked.

The liquid crystal panel 120a will be described later.

The first polarization panel 120b may be disposed between the backlight unit 110 and the liquid crystal panel 120a. If non-polarized light emitted from the backlight unit 110 is incident upon the first polarization panel 120b, only light having a first polarization axis may pass through the first polarization panel 120b.

In this case, light having passed through the first polarization panel 120b may be incident upon the liquid crystal panel 120a.

The second polarization panel 120c may be arranged to face the first polarization panel 120b on the basis of the liquid crystal panel 120a interposed there-between, and may have a second polarization axis perpendicular to the first polarization axis of the first polarization panel 120b.

That is, the second polarization panel 120c may be arranged at one surface of the liquid crystal panel 120a, and may polarize light of images generated by the liquid crystal panel 120a in one direction.

The display panel 120 may further include a transparent protective panel 120d disposed between the liquid crystal panel 120a and the second polarization panel 120c.

The protective panel 120d may be disposed between the second polarization panel 120c and the liquid crystal panel 120a so as to protect the liquid crystal unit 126 of the liquid crystal panel 120a.

The protective panel 120d may be a glass substrate, or may be a polymer film or substrate formed of polycarbonate (PC), polyethylene terephthalate (PET), polyacrylic, or the like.

In addition, the display apparatus 100 may further include a support member 131, a diffusion panel 113, and the other support member 132. The support member 131 may be disposed between the diffusion panel 113 and the light emitter 111, may maintain the distance between the diffusion panel 113 and the light emitter 111, and may fix the diffusion panel 113. The diffusion panel 113 may be disposed between the first polarization panel 120b and the optical sheet 114 so as to maintain the distance between the first polarization panel 120b and the optical sheet 114. The support member 132 may fix the optical sheet 114 and the display panel 120.

FIGS. 4 and 5 illustrate the display apparatus having the edge-type backlight unit. In more detail, FIG. 4 is an exploded perspective view illustrating the display apparatus having the edge-type backlight unit. FIG. 5 is a cross-sectional view illustrating the display apparatus shown in FIG. 4.

For convenience of description and better understanding of the present disclosure, it is assumed that a direction in which images of the display apparatus 100 are displayed will hereinafter be referred to as a forward direction, and the other direction opposite to the forward direction will hereinafter be referred to as a backward direction on the basis of the position of the display apparatus 100.

Referring to FIGS. 4 and 5, the display apparatus 100 may be coupled to the bezel 100a, and may further include a case 100c located in a rear part thereof so as to form an external appearance of the display apparatus 100.

The display apparatus 100 may include a backlight unit 110′ and a display panel 120, which are arranged between the bezel 100a and the case 100c.

In addition, the display apparatus 100 may further include a touch panel (not shown) provided at the front of the display panel 120.

The backlight unit 110′ may be disposed between the display panel 120 and the case 100c, may be spaced apart from the display panel 120 by a predetermined distance, and may emit light to the display panel 120.

The backlight unit 110′ may include a light emitter 115, a reflective panel 116, a light guide panel 117, a diffusion panel 113, and an optical sheet 114.

The light emitter 115 may be located adjacent to the case 100c, may be arranged at both sides of the case 100c, and may emit light to the light guide panel 117.

The light emitter 115 may include any one of a Cold Cathode Fluorescent Lamp (CCFL), an External Electrode Fluorescent Lamp (EEFL), and a Light Emitting Diode (LED).

The reflective panel 116 may be disposed between the light emitters 115, may be arranged at the rear of the light guide panel 117, and may reflect some part of light emitted from the light emitter to the light guide panel 117.

The reflective panel 116 may be manufactured using synthetic resins such as polycarbonate (PC) or polyethylene terephthalate (PET), or may be manufactured using various metal materials.

The light guide panel 117 may be disposed between the light emitters 115, and may be located adjacent to the reflective panel 116. If light emitted from the light emitter 115 is incident upon the light guide panel 117, the incident light may be directed to the display panel 120.

The light guide panel 117 may be implemented as a flat-type material using a plastic material such as polymethylmethacrylate corresponding to acrylic transparent resin acting as one of transmittance materials for light transmittance, or using polycarbonate (PC) series.

The light guide panel 117 may secure superior transparency, superior weatherproofing, and superior epiphytism, such that it can induce light diffusion during light transmission.

The diffusion panel 113 may be a translucent or semitransparent panel, which is disposed between the display panel 120 and the light guide panel 117 of the backlight unit and diffuses light emitted from the light guide panel 117 along the surface such that color and brightness of the entire screen of the display panel 120 can be uniform, thereby improving brightness of light emitted from the light emitter 115.

The backlight unit 110′ may further include one or at least two optical sheets 114.

The optical sheet 114 may equalize brightness of incident light, and may focus diffused light or high-brightness light, such that it can improve light characteristics.

One sheet from among the optical sheets 114 may selectively transmit light of a certain wavelength, and may allow another light having a different wavelength to be reflected onto the backlight unit, resulting in increased light transmission efficiency. The optical sheet may include a prism sheet in which a prism is formed.

The other optical sheet prevents light other than specific-wavelength light from being transmitted, such that the light can be polarized.

The optical sheet may include a Dual Brightness Enhancement Film (DBEF) caused by bi-refraction multi-coating.

The display panel 120 may be disposed in the case 100c, and may be a panel for converting electric information into image information using liquid crystal unit transmission change caused by the applied voltage. The display panel 120 may include a liquid crystal panel 120a, a first polarization panel 120b, a second polarization 120c, and a protective panel 120d.

The liquid crystal panel 120a may include a liquid crystal unit material, may adjust transmittance of transmission light by changing arrangement of liquid crystal unit, such that different colors are formed according to respective pixels.

By combination of colors of respective pixels formed by the liquid crystal panel 120a, images may be displayed on the display apparatus 100.

The liquid crystal panel 120a may include a substrate 121, a color filter 122, a first electrode unit 123, an insulator 124, a second electrode unit 125, and a liquid crystal unit 126.

In this case, the substrate 121, the color filter 122, the first electrode unit 123, the insulator 124, the second electrode unit 125, and the liquid crystal unit 126 may be sequentially stacked.

A method for manufacturing the liquid crystal panel will hereinafter be described. First, the first color filter, the first electrode unit, and the insulator are stacked on the substrate, several pixel electrodes are formed over one surface of the insulator in a manner that the pixel electrodes are spaced apart from each other by a predetermined distance, and the liquid crystal unit is coated over one surface of the insulator on which several pixel electrodes are arranged, such that the liquid crystal panel can be manufactured.

In this case, the liquid crystal unit may be a matrix in which liquid crystal unit capsules are accommodated.

The liquid crystal panel 120a will be described later.

The first polarization panel 120b may be disposed between the backlight unit 110′ and the liquid crystal panel 120a. If non-polarized light emitted from the backlight unit 110′ is incident upon the first polarization panel 120b, only light having a first polarization axis from among several incident lights may pass through the first polarization panel 120b.

In this case, light having passed through the first polarization panel 120b may be incident upon the liquid crystal panel 120a.

The second polarization panel 120c may be arranged to face the first polarization panel 120b on the basis of the liquid crystal panel 120a interposed there-between, and may have a second polarization axis perpendicular to the first polarization axis of the first polarization panel 120b.

That is, the second polarization panel 120c may be arranged at one surface of the liquid crystal panel 120a, and may polarize light of images generated from the liquid crystal panel 120a in one direction.

The display panel 120 may further include a transparent protective panel 120d disposed between the liquid crystal panel 120a and the second polarization panel 120c.

The protective panel 120d may be disposed between the second polarization panel 120c and the liquid crystal panel 120a so as to protect the liquid crystal unit 121 of the liquid crystal panel 120a.

That is, the protective panel 120d may be mounted to one surface of the liquid crystal panel 120a to prevent contact between the liquid crystal panel 120a and the outside air, such that it can prevent reduction of a lifespan of the liquid crystal unit formed of organic materials because the liquid crystal panel 120a contacting the air is formed of organic materials causing lifespan reduction.

The protective panel 120d may maintain the state or shape of the liquid crystal panel 120a.

For example, the protective panel 120d may maintain the original state of a coating film formed at the outer surface of the liquid crystal panel 120a.

The protective panel 120s may be a glass substrate, or may be a polymer film or substrate formed of polycarbonate (PC), polyethylene terephthalate (PET), polyacrylic, or the like.

The protective panel 120d may also be implemented using a protective panel film.

The protective panel 120d may be omitted from the display panel as necessary.

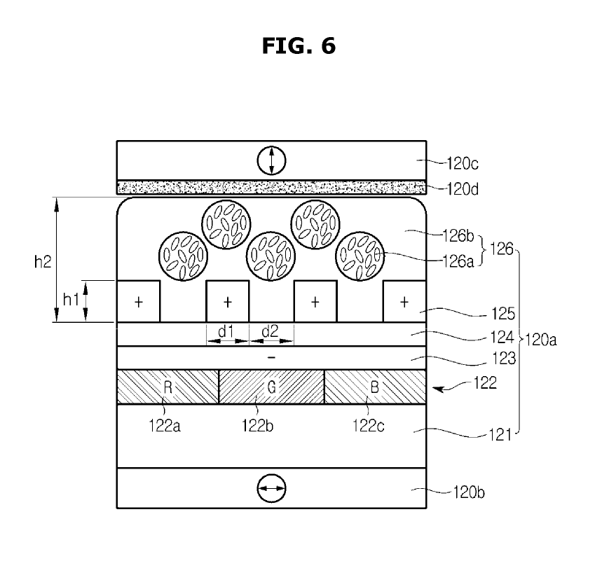

FIG. 6 is a detailed schematic view illustrating a display panel embedded in the display apparatus according to an embodiment of the present disclosure.

A display panel contained in the display apparatus having the direct-type backlight unit may be identical to a display panel contained in the display apparatus having the edge-type backlight unit.

The display panel according to one embodiment may include the liquid crystal panel 120a, the first polarization panel 120b mounted to one side of the liquid crystal panel 120a, the second polarization panel 120c mounted to the other side of the liquid crystal panel 120a, and the protective panel 120d disposed between the liquid crystal panel 120a and the second polarization panel 120c.

The liquid crystal panel 120a may include a substrate 121, a color filter 122, a first electrode unit 123, an insulator 124, a second electrode unit 125, and a liquid crystal unit 126, which are sequentially stacked.

The substrate 121 may be located adjacent to the first polarization panel 120b.

A plurality of color elements of the color filter 122 may be seated in the substrate 121.

The substrate 121 may support the first electrode unit 123, the insulator 124, the second electrode unit 125, and the liquid crystal unit 126 such that the positions and states of the first electrode unit 123, the insulator 124, the second electrode unit 125, and the liquid crystal unit 126 are maintained.

The substrate 121 may include a rigid substrate, a flexible substrate, or a rigid-flexible substrate.

If the substrate 121 is implemented as the flexible substrate, the display apparatus 100 may be curved at a predetermined curvature.

The color filter 122 may be disposed between the substrate 121 and the first electrode unit 123.

The color filter 122 may convert incident light into red-based light, green-based light, and blue-based light, and emit the red-based light, the green-based light, and the blue-based light.

The color filter 122 may include a red filter (R) 122a to convert incident light into red-based light; a green filter (G) 122b to convert incident light into green-based light; and a blue filter (B) 122c to convert incident light into blue-based light.

In this case, the red filter 122a, the green filter 122b, and the blue filter 122c may be arranged adjacent to one another, and may construct a single RGB filter. The single RGB filter may form a single pixel.

That is, the color filter 122 may include a plurality of unit pixels (RGB filters) corresponding to the respective pixels.

A black matrix (not shown) may be provided not only at the border between the unit pixels, but also at the border between the RGB filters.

This black matrix may serve as a light shielding film between the color filters, such that it implements desired colors, prevents light leakage, and increases color contrast.

The color filter 122 may emit at least one of red-based light emitted from the red filter, green-based light emitted from the green filter, and blue-based light emitted from the blue filter to the outside, or may mix at least two of the red-based light emitted from the red filter, the green-based light emitted from the green filter, and the blue-based light emitted from the blue filter and may output the mixed light to the outside, such that the color filter 122 can produce desired colors.

Lights of the respective filters contained in the color filter 122 may be emitted to the outside after passing through the first electrode unit 123, the insulator 124, and the second electrode unit 125, and the liquid crystal unit 126.

The first electrode unit 123 may be disposed between the color filter 122 and the insulator 124.

The first electrode unit 123 may be a common electrode, such that electric field can be formed between the first electrode unit 123 and the second electrode unit 125.

The first electrode unit 123 and the second electrode unit may apply a current to the liquid crystal unit, resulting in orientation of liquid crystal unit molecules contained in the liquid crystal unit capsule of the liquid crystal unit.

The insulator 124 may be disposed between the first electrode unit 123 and the second electrode unit 125 so as to achieve electric insulation between the first electrode unit 123 and the second electrode unit 125.

The insulator 124 may be formed of a transparent material through which light having passed through the first polarization panel 120b and the substrate 123 can pass.

For example, the insulator 124 may be formed of synthetic resin (e.g., acrylic resin), or may be formed of glass or the like.

The insulator 124 may include a rigid substrate, a flexible substrate, or a rigid-flexible substrate according to implementation examples of the display apparatus.

In this case, the rigid-flexible substrate may be a multilayer substrate formed by stacking of flexible substrates or rigid substrates.

The second electrode unit 125 may include a plurality of pixel electrodes configured to form an electric field using electric flux of the first electrode unit.

The pixel electrodes of the second electrode unit 125 may be spaced apart from one another at intervals of a predetermined distance, and may be inserted into the liquid crystal unit 126 by coating the liquid crystal unit 126.

That is, the pixel electrodes may be interposed between the insulator 124 and the liquid crystal unit 126, may be accommodated in a matrix of the liquid crystal unit, and may be spaced apart from one another at intervals of a predetermined distance within the matrix.

The arrangement pattern of the pixel electrodes of the second electrode unit 125 may correspond to the respective pixels of the display panel 120.

The pixel electrodes of the second electrode unit 125 may be electrically charged with a different polarity from the first electrode unit 123.

For example, assuming that the first electrode unit 123 is a positive-polarity electrode, the second electrode unit 125 may be a negative-polarity electrode. Assuming that the first electrode unit 123 is a negative-polarity electrode, the second electrode unit 125 may be a positive-polarity electrode.

The second electrode unit 125 may be arranged to face the first electrode unit 123 on the basis of the insulator 124, and may apply a current to the liquid crystal unit 126 in conjunction with the first electrode unit 123.

In addition, each pixel electrode of the second electrode unit 125 may be implemented using a Thin Film Transistor (TFT).

The pixel electrodes may have the same width (d1), and may be spaced apart from one another by the same distance (d2).

In this case, the width (d1) of each pixel electrode may be less than the distance (d1) between the neighboring pixel electrodes.

The length or height (h1) of each pixel electrode of the second electrode unit may be larger than ⅓ or higher of the length or height (h2) of the liquid crystal unit 126.

Each of the first electrode unit and the second electrode unit may have a Fringe-Field Switching (FFS)—type electrode structure in which the electric field is constructed in a manner that the surface (i.e., the surface of the substrate) of the display panel and the liquid crystal unit are arranged in the horizontal direction.

In this case, the FFS-type electrode arrangement structure may include a Plane to Line Switching (PLS)-type electrode arrangement structure or an ADS-type electrode arrangement structure.

This embodiment of the present disclosure reduces the distance between the electrodes and improves a liquid crystal unit operation structure using the above-mentioned electrode structures, such that transmittance and the viewing angle are increased.

The liquid crystal unit 126 may be arranged between the first polarization panel 120b and the protective panel 120d. If incident light occurs, bi-refraction of the incident light is induced according to the electric field applied to the plurality of liquid crystal unit capsules.

The liquid crystal unit 126 may include a plurality of liquid crystal unit capsules 126a, and the matrix 126d to accommodate the plurality of liquid crystal unit capsules 126a therein.

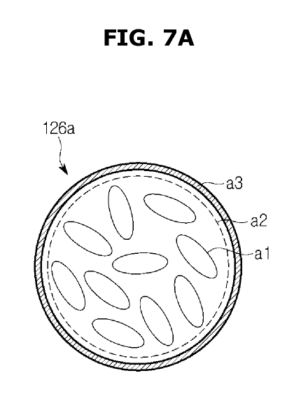

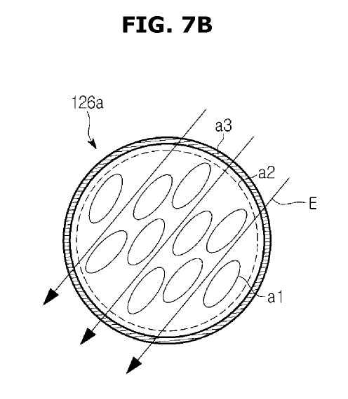

The liquid crystal unit capsule 126a will hereinafter be described with reference to FIGS. 7A and 7B.

FIG. 7A is a view illustrating an example of the liquid crystal unit capsule embedded in the display apparatus. FIG. 7B is a view illustrating application of an electric field is applied to the liquid crystal unit capsule shown in FIG. 7A.

Referring to FIGS. 7A and 7B, the liquid crystal unit capsule 126a may be a capsule form of the liquid crystal unit molecules (a1), and may include the liquid crystal unit molecules (a1) therein.

The liquid crystal unit capsule 126a may have a nano-scale structure, for example, may have a circular or oval shape having a diameter of about 10 nm to 300 nm.

The liquid crystal unit capsule 126a may be manufactured by interfacial polymerization, complex coacervation, membrane emulsification, or in-situ polymerization.

In more detail, the liquid crystal unit capsule 126a may include liquid crystal unit molecules (a1), a surfactant (interfacial active agent) (a2), and a capsule outer wall layer (a3).

The liquid crystal unit molecules (a1) may be distributed in the capsule outer wall layer (a3) of the liquid crystal unit capsule 126a.

As can be seen from FIG. 7A, if an electric field is not formed in the liquid crystal unit capsule 126a, the liquid crystal unit molecules (a1) may be arranged in the capsule outer wall layer (a3) at random.

As can be seen from FIG. 7B, if electric field is formed in the liquid crystal unit capsule 126a, the liquid crystal unit molecules (a1) may be arranged in the direction of the formed electric field.

The liquid crystal unit molecules (a1) may include a positively charged liquid crystal unit molecule or a negatively charged liquid crystal unit molecule.

The positively charged liquid crystal unit molecule may be a liquid crystal unit molecule arranged parallel to the received electric field direction, and the negatively charged liquid crystal unit molecule may be a liquid crystal unit molecule arranged perpendicular to the received electric field direction.

For example, assuming that the liquid crystal unit molecules (a1) are positively charged liquid crystal unit molecules and the electric field is formed in or oriented a downward direction (i.e., from the UP direction to the DOWN direction), the liquid crystal unit molecules (a1) may be arranged (or aligned) in the electric field direction, as shown in FIG. 7B.

The surfactant (a2) may be distributed in the capsule outer wall layer (a3) of the liquid crystal unit capsule 126a.

The surfactant (a2) may change an interactive force between the capsule outer wall layer (a3) and the liquid crystal unit molecules (a1), such that the liquid crystal unit molecules (a1) may move relatively freely or pivot within the capsule outer wall layer (a3).

Therefore, the liquid crystal unit molecules (a1) contained in the liquid crystal unit capsule 126a may be relatively easily aligned.

The surfactant (a2) may be implanted as an additive agent in the liquid crystal unit capsule (a1).

If the surfactant (a2) is implanted in the liquid crystal unit capsule 126a, the surfactant (a2) may be mainly distributed in the inner surface of the capsule outer wall layer (a3) as shown in FIGS. 7A and 7B, such that interactive force between the capsule outer wall layer (a3) and the liquid crystal unit molecule (a1) may be changed.

In accordance with one embodiment, the surfactant (a2) may also be omitted as necessary.

The capsule outer wall layer (a3) may be formed to include liquid crystal unit molecules (a1) therein. If necessary, the capsule outer wall layer (a3) may further include the surfactant (a2) therein.

The capsule outer wall layer (a3) may protect the plurality of liquid crystal unit molecules (a1) at the inside thereof, and several liquid crystal unit molecules (a1) are separated from the polymer matrix 126b such that several liquid crystal unit molecules (a1) are prevented from being distributed in or leaked into the liquid crystal unit 126 according to deformation of the polymer matrix 126b caused by external pressure or the like.

The capsule outer wall layer (a3) may be manufactured using a chemical compound (e.g., a polymer) having a high molecular weight.

In accordance with one embodiment, dielectric constant (permittivity) (Δ∈) of the liquid crystal unit molecules (a1) may be set to the value of 10 or greater.

In addition, assuming that the liquid crystal unit molecules (a1) are aligned as shown in FIG. 7B, a double refraction (bi-refraction) value (Δn) of the liquid crystal unit molecules (a1) 3 may be set to 0.1 or greater. This bi-refraction value (Δn) may indicate optical anisotropy.

The matrix 126b may be a polymer matrix having the plurality of liquid crystal unit capsules 126a.

The polymer matrix may be an organism formed of a polymer having a relatively high molecular weight.

The polymer matrix may be formed of a transparent material. For example, the polymer matrix may be formed of synthetic resins.

For example, the polymer matrix may be formed of epoxy, polyurethane, methacrylic acid, dicyclopentadiene epoxy, polydicyclopentadiene, polyimide, or the like.

The plurality of liquid crystal unit capsules 126a may be distributed in the polymer matrix at random.

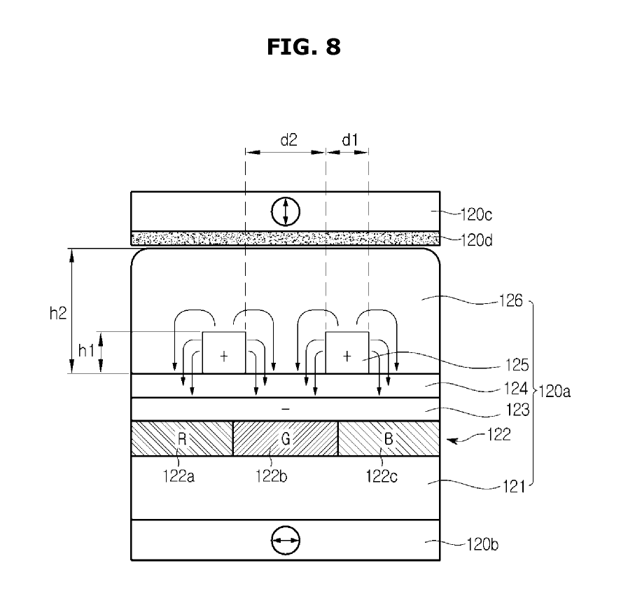

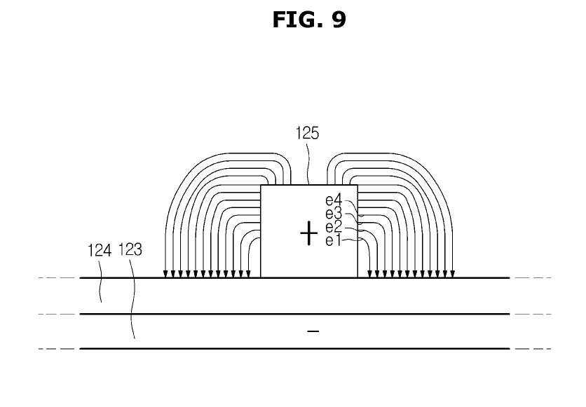

Examples of light transmission and light interruption of the display panel in which the liquid crystal unit having the liquid crystal unit capsule is provided will hereinafter be described with reference to FIGS. 8 and 9.

FIG. 8 is a view illustrating that an electric field contained in the display panel is formed when a power-supply voltage is applied to the display apparatus according to an embodiment of the present disclosure. FIG. 9 is a detailed view illustrating the electric field shown in FIG. 8.

Referring to FIG. 8, the plurality of pixel electrodes of the second electrode unit may have the same width (d1), and may be spaced apart from each other by the same distance (d2).

In this case, the width (d1) of each pixel electrode may be less than the distance (d2) between the neighboring pixel electrodes.

The length or height (h1) of the pixel electrode of the second electrode unit 120c may be larger than ⅓ or higher of the length or height (h1) of the liquid crystal unit 126.

In this case, the length or height (h2) of the liquid crystal unit 126 may indicate the distance between one surface and the other surface of the liquid crystal unit 126.

One surface of the liquid crystal unit 126 may contact the insulator 126, and the other surface of the liquid crystal unit 126 may contact the protective panel 120d.

In this case, the length or height (h2) of the liquid crystal unit 126 may be determined to exceed half a ratio of a wavelength (λ) of the incident light to a bi-refraction value (Δn) of the liquid crystal unit molecules (a1) of the liquid crystal unit capsule 126a distributed in the liquid crystal unit 126.

In other words, the relationship among the length or height (h2) of the liquid crystal unit 126, the bi-refraction value (Δn) of the liquid crystal unit molecules (a1), and wavelength (λ) of light (L) may be represented by the following equation.

Δn×h2>0.5λ [Equation]

As described above, An may be set to 0.1 or higher.

Assuming that the product (i.e., the left-hand side of Equation 1) of the bi-refraction value (Δn) and the length or height (h2) is equal to or less than 0.5λ, no light may be emitted from the display panel. Alternatively, although light is emitted from the display panel, brightness of the emitted light is reduced.

Although the electric field is formed in the liquid crystal unit 126, not all the liquid crystal unit capsules 126a may be affected by the electric field, such that the brightness of the emitted light is reduced.

Assuming that the length or height (h2) of the liquid crystal unit 126 is determined to exceed the half the ratio of a wavelength (λ) of the incident light to a bi-refraction value (Δn) of the liquid crystal unit molecules (a1), brightness of light emitted from the display panel 120 is not decreased although the electric field is formed only in some liquid crystal unit capsules 126a.

In more detail, assuming that the length or height (h2) of the liquid crystal unit 126 exceeds half the ratio of a wavelength (λ) of the incident light to the bi-refraction value (Δn) of the liquid crystal unit molecules (a1), a polarization axis of the light L incident upon the liquid crystal unit 126 is sufficiently changed according to the polarization axis of the second polarization panel 120c, such that light having passed through the liquid crystal unit 126 may be appropriately emitted to the second polarization panel 120c.

Therefore, the still image or moving images to be displayed on the display panel 120 may be displayed with sufficient brightness, resulting in improved image visibility.

If a power-supply voltage is applied not only to a common electrode of the first electrode unit 123, but also to the plurality of pixel electrodes of the second electrode unit 125, the electric field is formed between the common electrode and the plurality of pixel electrodes.

A plurality of electric fluxes corresponding to the movement path along which positive charges can receive force may be formed in the electric field.

The electric fluxes may start from the positive charges (i.e., a high-potential point), or may stop either at the negative chargers (i.e., a low-potential point) or at the infinite point.

The electric fluxes (e1 to e4) may move in the perpendicular direction from the surface of the positive electrode. During such movement, the electric fluxes (e1 to e4) move toward the negative electrodes. During such movement, the electric fluxes may not be separated from each other or may not cross each other.

In addition, the electric fluxes are characterized in that they are collected at the corner part of the negative or positive electrode.

It is assumed that the pixel electrodes are positive electrodes and the common electrode is a negative electrode.

In this case, the electric field in which electric charges leak from the pixel electrode and are applied to the common electrode, may be formed in the display panel.

Electric fluxes generated from the electric field leakage part may be formed perpendicular to the surface of the pixel electrode, and may be formed not to cross the other neighboring electric fluxes.

In this case, the electric fluxes of the electric field leakage part may be formed in the vicinity of the pixel electrode.

Since the electric fluxes generated from the peripheral part of the pixel electrode do not cross each other, the electric fluxes further move in the direction perpendicular to the pixel electrode as the distance from the common electrode increases, and then move toward the common electrode.

Referring to FIG. 9, the first electric flux (e1) moves in the perpendicular direction from the surface of the pixel electrode by a first distance, and moves toward the common electrode. The second electric flux (e2) moves in the perpendicular direction from the surface of the pixel electrode by a second distance, moves by a longer distance than the first distance in a manner that the second electric flux (e2) does not cross the first electric flux, and then moves toward the common electrode.

The third electric flux (e3) may move in the perpendicular direction from the surface of the pixel electrode by a third distance, and may move by a longer distance than the second distance in a manner that the third electric flux (e3) does not cross the first electric flux and the second electric flux. The fourth electric flux (e4) may move in the perpendicular direction from the surface of the pixel electrode by a fourth distance, may move by a longer distance than the third distance in a manner that the fourth electric flux (e4) does not cross the first, second, and third electric fluxes, and may finally move toward the common electrode.

That is, when the electric fluxes move toward the common electrode, the electric fluxes move in the direction parallel to the longitudinal direction of the pixel electrode. In addition, the direction of the electric fluxes may be perpendicular to the surface direction of the substrate unit.

In this case, the electric fluxes generated from the peripheral part of the pixel electrode may be generated in the direction nearly perpendicular to the surface of the pixel electrode, and may be generated from the electric field leakage part.

The electric fluxes arranged nearly perpendicular to the substrate may be formed by a longer distance as the distance from the common electrode increases (i.e., as the distance to the protective panel decreases).

In other words, since the pixel electrode is formed by a longer distance, the length of the electric fluxes arranged parallel to the substrate becomes longer as the distance from the insulator to the protective panel becomes shorter. As a result, the ratio of electric fluxes arranged parallel to the substrate from among the electric fluxes contained in the electric field can be increased.

Therefore, the ratio of electric fluxes arranged nearly parallel to the substrate from among the electric fluxes generated in the electric field formed in the liquid crystal unit can be increased.

As described above, the length of the pixel electrode is ⅓ or more times the length or of the liquid crystal unit 126, such that the ratio of the transverse electric field to the plane direction of the substrate can be increased as compared to the other case in which the length of the pixel electrode is ⅓ or less of the length of the liquid crystal unit 126.

The display panel may form the electric field, the direction of which is changed within the liquid crystal unit 126, such that the resultant electric field moves toward the first electrode unit. The ratio of electric fluxes arranged parallel to the substrate (i.e., the surface of the display panel) to the other electric fluxes arranged perpendicular to the substrate is increased, such that a transverse electric field ratio can be increased.

If the electric field is formed in the liquid crystal unit 126 as described above, the electric field having a predetermined direction (i.e., the transverse electric field) may be applied to the liquid crystal unit molecules (a1) contained in the liquid crystal unit capsule 126a.

If the electric field having the predetermined direction is applied to the liquid crystal unit molecules (a1), the liquid crystal unit molecules (a1) may be aligned in a predetermined direction, and light incident upon the liquid crystal unit 126 may be bi-refracted according to arrangement of the liquid crystal unit molecules (a1) contained in the liquid crystal unit 126, and the incident light may be emitted to the outside.

In addition, assuming that each of the pixel electrodes is a negative electrode and the common electrode is a positive electrode, the electric field in which electric charges leak from the common electrode and are applied to the pixel electrode may be formed in the display panel.

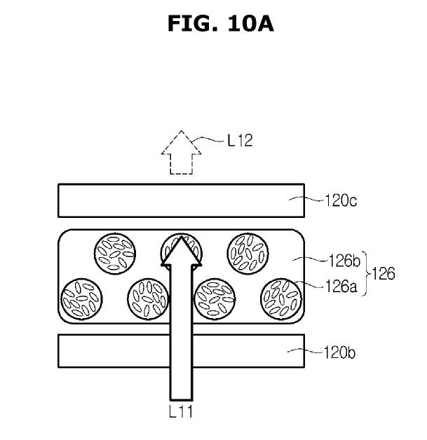

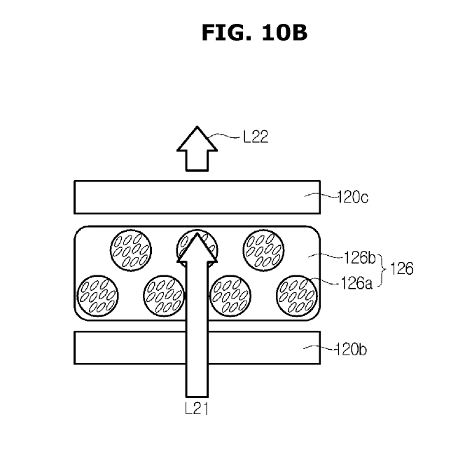

FIG. 10A is a view illustrating an example of an optical path within the display panel when a power-supply voltage is not applied to the display apparatus according to an embodiment of the present disclosure. FIG. 10B is a view illustrating an example of an optical path within the display panel when a power-supply voltage is applied to the display apparatus according to an embodiment of the present disclosure.

Referring to FIG. 10A, assuming that the electric field is not formed in the liquid crystal unit 126, the liquid crystal unit molecules (a1) contained in the liquid crystal unit capsule 126a may be arranged at random.

In this case, light (L11) having passed through the first polarization panel 120b and the liquid crystal unit capsule 126a because of bi-refraction does not occur may not pass through the second polarization panel 120c as shown in L12.

Therefore, light may not be emitted to the outside through the second polarization panel 120c, and the display panel 120 may be displayed in black.

In contrast, as shown in FIG. 10B, if the electric field is formed in the liquid crystal unit 126, the liquid crystal unit molecules (a1) may be aligned in the liquid crystal unit capsule 126a.

In this case, light (L21) incident upon the liquid crystal unit 126 after passing through the first polarization panel 120b may cause or undergo bi-refraction after passing through the liquid crystal unit capsule 126a, such that light (L12) having passed through the first polarization panel 120b and the liquid crystal unit 126 may be emitted to the outside through the second polarization panel 120c as shown in L22.

Therefore, assuming that the electric field is formed in the liquid crystal unit 126, the display panel 120 may emit different colors of light respectively formed by several pixels to the outside.

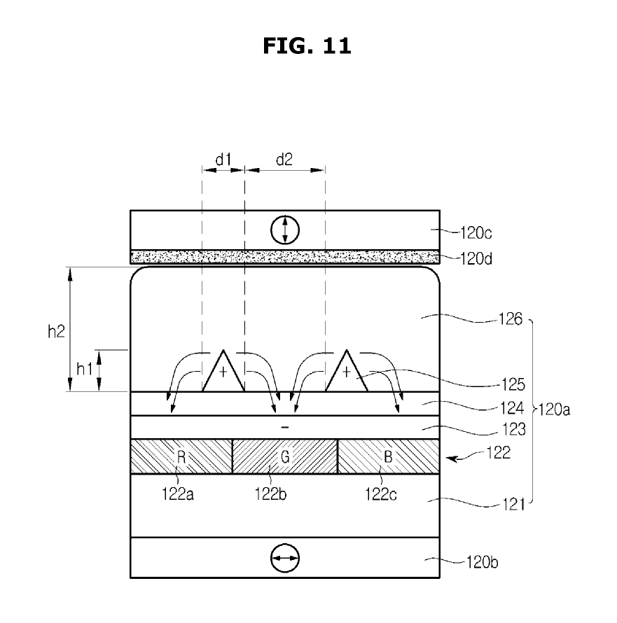

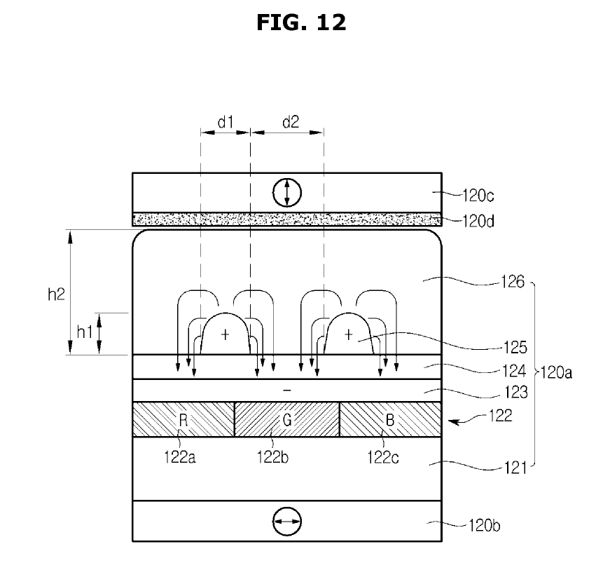

Although the pixel electrode of the second electrode unit according to one embodiment has a square cross-section, the pixel electrode of the second electrode unit may be formed in a triangular shape as shown in FIG. 11, or may be formed in a circular or oval shape as shown in FIG. 12.

In this case, the pixel electrode may be formed in a cross-sectional shape.

In this case, the pixel electrode of the second electrode unit may have a three-dimensional (3D) shape protruding from the insulator to the liquid crystal unit.

Referring to FIG. 11, the pixel electrode of the second electrode unit may be formed in a three-dimensional (3D) shape, and the width (d1) of the pixel electrode of the second electrode unit may be smaller than the distance (d1) between the pixel electrodes.

The length (i.e., the height of a triangle) of the pixel electrode of the second electrode unit may be equal to or longer than ⅓ of the length or height of the liquid crystal unit 126.

Referring to FIG. 12, the pixel electrode of the second electrode unit may be formed in a three-dimensional (3D) shape having an oval cross-section, and the diameter of the pixel electrode of the second electrode unit may be less than the distance between the pixel electrodes.

The length (i.e., the height of an oval) of the second electrode unit may be equal to or longer than ⅓ of the length or height of the liquid crystal unit 126.

As described above, the length of the pixel electrode (i.e., the height of an oval) of the second electrode unit may be equal to or longer than ⅓ of the length or height of the liquid crystal unit 126, such that the ratio of the transverse electric field can be greatly increased as compared to the case in which the length or height of the pixel electrode is less than ⅓ of the length or height of the liquid crystal unit 126.

In addition, the ratio of the electric field parallel to the surface of the substrate may greatly increase as compared to the other electric field perpendicular to the surface of the substrate.

The display apparatus 100 may further include a drive module for image control.

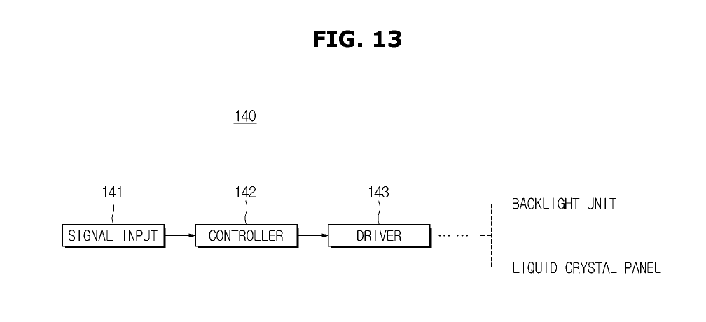

A detailed description thereof will hereinafter be described with reference to FIG. 13.

FIG. 13 is a block diagram illustrating the display apparatus according to an embodiment of the present disclosure.

Referring to FIG. 13, the drive module 140 of the display apparatus 100 may include a signal input 141, a controller 142, and a driver 143, and may further include a power-supplier.

The signal input 141 may receive image signals contained in the external broadcast signal, may receive image signals stored in the storage medium (not shown), and may transmit the received image signals to the controller 142.

The controller 142 may control a power-supplier (not shown), a backlight unit 110, and a display panel 120, or the like, such that the display apparatus 100 may display still images or moving images.

The controller 142 may transmit a drive signal corresponding to the received image information to the display panel.

The drive signal may be a signal to be applied to the pixel electrodes of the second electrode unit according to the respective pixels.

The controller 142 may include at least one processor, a central processing unit (CPU), a micro-processing unit (MCU), etc. The processor, the CPU, and the MCU may be implemented as at least one or two semiconductor chips, and may be implemented using various electronic components to operate the semiconductor chip.

The driver 143 may drive the display panel on the basis of a command of the controller 142, resulting in formation of images corresponding to the image information.

That is, the driver 143 may transmit the per-pixel voltage corresponding to the drive signal of the controller 142 to the respective pixel electrodes.

The power-supplier (not shown) may provide power needed to display images to the display panel 120 or the backlight unit 110.

The power-supplier may be connected to the external commercial power source. In this case, the power-supplier may rectify AC power source received from the commercial power source into DC power source needed to operate the display apparatus 100, may change a voltage to a necessary voltage level, or may remove noise from the DC power source.

The power-supplier may include a battery configured to store power.

In this case, the battery may be implemented as a rechargeable battery.

The display apparatus 100 may further include a storage (not shown) configured to store various kinds of data so as to assist operations of the processor. The storage may be implemented using a semiconductor storage unit such as ROM/RAM or a Solid State Drive (SSD), or using a magnetic disk storage unit such as a Hard Disk Drive (HDD).

The backlight unit 110 mat generate light according to a command of the controller 142, and may emit the generated light to the display panel 120.

The display panel 120 may modulate the incident light for each pixel upon receiving the command from the controller 142, such that images are displayed on the display panel 120.

The display panel 120 may allow light received from the backlight unit 110 to be incident upon one surface thereof, may adjust light corresponding to each pixel, and may emit the adjusted light to the outside.

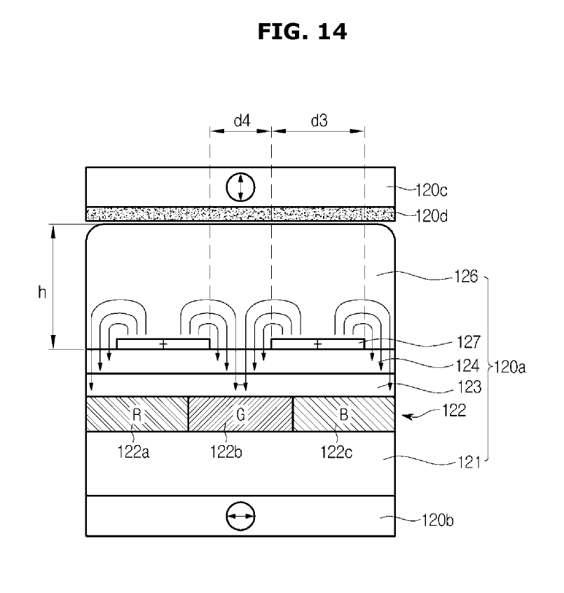

FIG. 14 is a view illustrating the display panel embedded in the display apparatus according to another embodiment of the present disclosure.

Referring to FIG. 14, the display apparatus according to another embodiment may include a backlight unit and a display panel.

The backlight unit according to another embodiment may be an edge-type backlight unit or a direct-type backlight unit in the same manner as in the above-mentioned embodiment, and as such a detailed description thereof will herein be omitted for convenience of description.

The display panel 120 may convert electrical information into image information using the change of liquid crystal unit transmittance according to the reception voltage. The display panel 120 may include a liquid crystal panel 120a, a first polarization panel 120b, a second polarization panel 120c, and a protective panel 120d.

In this case, the first polarization panel 120b, the second polarization panel 120c, and the protective panel 120d according to another embodiment are identical to those of the above-mentioned embodiment, and as such a detailed description thereof will herein be omitted for convenience of description.

The liquid crystal panel 120a may include a liquid crystal unit, and may adjust transmittance of light by changing arrangement of the liquid crystal unit, such that different colors may be formed according to respective pixels.

By combination of per-pixel colors formed by the liquid crystal panel 120a, images may be displayed on the display apparatus 100.

The liquid crystal panel 120a may include a substrate 121, a color filter 122, a first electrode unit 123, an insulator 124, a second electrode unit 127, and a liquid crystal unit 126.

In this case, the substrate 121, the color filter 122, the first electrode unit 123, the insulator 124, the second electrode unit 125, and the liquid crystal unit 126 may be sequentially stacked.

The substrate 121, the color filter 122, the first electrode unit 123, the insulator 124, and the liquid crystal unit 126 are identical to those of the above-mentioned embodiment, and as such a detailed description thereof will herein be omitted or will hereinafter be briefly described.

The substrate 121 may be located adjacent to the first polarization panel 120b.

The plurality of color elements of the color filter 122 may be seated in the substrate 121.

The color filter 122 may be disposed between the substrate 121 and the first electrode unit 123.

The color filter 122 may convert incident light into red-based light, green-based light, and blue-based light, and may emit the resultant light to the outside.

The color filter 122 may include a red filter (R) 122a to convert incident light into red-based light; a green filter (G) 122b to convert incident light into green-based light; and a blue filter (B) 122c to convert incident light into blue-based light.

In this case, the red filter 122a, the red filter 122b, and the blue filter 122c may be located adjacent to one another, and may construct a single RGB filter. The single RGB filter may form a single pixel.

That is, the color filter 122 may include the plurality of unit pixels (RGB filters) corresponding to the respective pixels.

A black matrix (not shown) may be provided not only at the border between the unit pixels, but also at the border between the RGB filters.

This black matrix may serve as a light shielding film between the color filters, such that it implements desired colors, prevents light leakage, and increases color contrast.

The first electrode unit 123 may be disposed between the color filter 122 and the insulator 124.

The first electrode unit 123 may be a common electrode, such that electric field can be formed between the first electrode unit 123 and the second electrode unit 127.

The first electrode unit 123 may be a positively charged electrode or a negatively charged electrode.

The first electrode unit 123 and the second electrode unit 127 may apply a current to the liquid crystal unit, resulting in orientation of liquid crystal unit molecules contained in the liquid crystal unit capsule of the liquid crystal unit.

The insulator 124 may be disposed between the first electrode unit 123 and the second electrode unit 127 so as to achieve electric insulation between the first electrode unit 123 and the second electrode unit 127.

The insulator 124 may be formed of a transparent material through which light having passed through the first polarization panel 120b and the substrate 121 can pass.

The second electrode unit 127 may form the electric field using electric force of the first electrode unit.

The second electrode unit 127 may include a plurality of pixel electrodes disposed between the insulator 124 and the liquid crystal unit 126.

The pixel electrodes of the second electrode unit 127 may be spaced apart from one another at intervals of a predetermined distance in the insulator 124, and may be inserted into the liquid crystal unit 126 by coating the liquid crystal unit 126.

That is, according to a method for fabricating the liquid crystal panel, the color filter, the first electrode unit, and the insulator are stacked over the substrate, the pixel electrodes are spaced apart from each other by a predetermined distance at one surface of the insulator, and the liquid crystal unit is coated over one surface of the insulator in which the pixel electrodes are arranged, resulting in formation of the liquid crystal panel.

In this case, the liquid crystal unit may be a matrix including the liquid crystal unit capsules.

The arrangement pattern of the pixel electrodes of the second electrode unit 127 may correspond to the respective pixels of the display panel 120.

The pixel electrodes of the second electrode unit 125 may be charged with a different polarity from the first electrode unit 123.

For example, assuming that the first electrode unit 123 is a positive electrode, the second electrode unit 127 may be a negative electrode. Assuming that the first electrode unit 123 is a negative electrode, the second electrode unit 127 may be a positive electrode.

The second electrode unit 127 may be arranged to face the first electrode unit 123 on the basis of the insulator 124, and may apply a current to the liquid crystal unit 126 in conjunction with the first electrode unit 123.

The pixel electrodes of the second electrode unit 127 may have the same width (d3), and may be spaced apart from one another by the same distance (d4).

In this case, the width (d3) of each pixel electrode of the second electrode unit 127 may be larger than the distance (d4) between the neighboring pixel electrodes.

Each of the first electrode unit and the second electrode unit may have a Fringe-Field Switching (FFS)—type electrode structure in which the electric field is constructed in a manner that the surface (i.e., the surface of the substrate) of the display panel and the liquid crystal unit are arranged in the horizontal direction.

In this case, the FFS-type electrode arrangement structure may include a Plane to Line Switching (PLS)-type electrode arrangement structure or an ADS-type electrode arrangement structure.

The liquid crystal unit 126 may be arranged between the first polarization panel 120b and the protective panel 120d. If incident light occurs, bi-refraction of the incident light is induced according to the electric field applied to the plurality of liquid crystal unit capsules.

In this case, the length or height (h) of the liquid crystal unit 126 may exceed the half the ratio of a wavelength (λ) of the incident light (L) to a bi-refraction value (Δn) of the liquid crystal unit molecules (a1) of the liquid crystal unit capsule 126a distributed in the liquid crystal unit 126.

The liquid crystal unit 126 may include a plurality of liquid crystal unit capsules 126a and the matrix 126b having the plurality of liquid crystal unit capsules 126a in the same manner as in the above-mentioned embodiment, and as such a detailed description thereof will herein be omitted for convenience of description.

If a power-supply voltage is supplied not only to the common electrode of the first electrode unit 123 but also to the plurality of pixel electrodes of the second electrode unit 125, the electric field is formed between the common electrode and the pixel electrodes.

A plurality of electric fluxes corresponding to the movement path along which positive charges can receive force may be formed in the electric field of the display panel according to another embodiment.

The electric fluxes may start from the positive charges (i.e., a high-potential point), or may stop either at the negative chargers (i.e., a low-potential point) or at the infinite point.

The electric fluxes may move in the perpendicular direction from the surface of the positive electrode. During such movement, the electric fluxes move toward the negative electrodes. During such movement, the electric fluxes may not be separated from each other or may not cross each other.

In addition, the electric fluxes are characterized in that they are collected at the corner part of the negative or positive electrode.

It is assumed that the pixel electrodes are positive electrodes and the common electrode is a negative electrode.

In this case, the electric field in which electric charges leak from the pixel electrode and are applied to the common electrode, may be formed in the display panel 120.

Electric fluxes generated from the electric field leakage part may be formed perpendicular to the surface of the pixel electrode, may be formed not to cross the other neighboring electric fluxes, and may move toward the common electrode.

In this case, the electric fluxes of the electric field leakage part may be formed in the vicinity of the pixel electrode.

When electric fluxes moves toward the common electrode of the first electrode unit, the electric fluxes may be generated parallel to the substrate 121.

Therefore, the ratio of electric fluxes arranged nearly parallel to the substrate 121 from among the electric fluxes generated in the electric field can be increased.

The display panel may form the electric field, the direction of which is changed within the liquid crystal unit 126, such that the resultant electric field moves toward the first electrode unit 123. The ratio of electric fluxes arranged parallel to the substrate 121 to the other electric fluxes arranged perpendicular to the substrate 121 is increased, such that a transverse electric field ratio can be increased.

If the electric field is formed in the liquid crystal unit 126 as described above, the electric field having a predetermined direction (i.e., the transverse electric field) may be applied to the liquid crystal unit molecules (a1) contained in the liquid crystal unit capsule 126a.

If the electric field having the predetermined direction is applied to the liquid crystal unit molecules (a1), the liquid crystal unit molecules (a1) may be aligned in a predetermined direction, and light incident upon the liquid crystal unit 126 may be bi-refracted according to arrangement of the liquid crystal unit molecules (a1) contained in the liquid crystal unit 126, and the incident light may be emitted to the outside.

In addition, assuming that each of the pixel electrodes is a negative electrode and the common electrode is a positive electrode, the electric field in which electric charges leak from the common electrode and are applied to the pixel electrode may be formed in the display panel.

Assuming that the electric field is not formed in the liquid crystal unit 126, of the display panel, the liquid crystal unit molecules (a1) contained in the liquid crystal unit capsule 126a may be arranged at random.

In this case, light having passed through the first polarization panel 120b and the liquid crystal unit capsule 126a because bi-refraction does not occur may not pass through the second polarization panel 120c.

Therefore, light may not be emitted to the outside through the second polarization panel 120c, and the display panel 120 may be displayed in black.

In contrast, if the electric field is formed in the liquid crystal unit 126, the liquid crystal unit molecules (a1) may be aligned in the liquid crystal unit capsule 126a.

In this case, light incident upon the liquid crystal unit 126 after passing through the first polarization panel 120b may cause bi-refraction after passing through the liquid crystal unit capsule 126a, such that light having passed through the first polarization panel 120b and the liquid crystal unit 126 may be emitted to the outside through the second polarization panel 120c.

Therefore, assuming that the electric field is formed in the liquid crystal unit 126, the display panel 120 may emit different colors of light respectively formed by several pixels to the outside.

The display apparatus according to another embodiment may further include a backlight unit and a drive module configured to drive the display panel.

The drive module according to another embodiment is identical to that of the above-mentioned embodiment, and as such a detailed description thereof will herein be omitted for convenience of description.

As is apparent from the above description, the display apparatus according to the embodiments can allow electric flux (i.e., electric flux of an incoming or outgoing part) generated in the vicinity of a pixel electrode from among electric fluxes of an electric field formed between the pixel electrode and a common electrode to be generated parallel to the surface of a display panel, and can allow the electric flux parallel to the peripheral part of the pixel electrode to have a predetermined length or height or longer, thereby improving brightness of the display apparatus.

Therefore, the embodiments of the present disclosure can improve an image display quality of the display apparatus.

Therefore, the embodiments of the present disclosure can improve the image quality and commercial value of the display apparatus, can increase user satisfaction, and can guarantee competitiveness of the display apparatus.

Although a few embodiments of the present disclosure have been shown and described, it would be appreciated by those skilled in the art that changes may be made in these embodiments without departing from the principles and spirit thereof, the scope of which is defined in the claims and their equivalents.

What is claimed is:

1. A display apparatus having a backlight unit and a display panel, comprising:
the display panel comprising:
a first electrode unit having a common electrode;
a second electrode unit having a different polarity from the first electrode unit, and configured to include a plurality of pixel electrodes each forming an electric field using an electric force of the first electrode unit;
an insulator disposed between the first electrode unit and the second electrode unit to achieve electric insulation between the first electrode unit and the second electrode unit; and
a liquid crystal unit located adjacent to the insulator where several of the pixel electrodes of the second electrode unit are inserted in the liquid crystal unit,
wherein a height of the pixel electrodes of the second electrode unit is equal to or greater than ⅓ the height of the liquid crystal unit.

2. The display apparatus according to claim 1, wherein:
a width of each pixel electrode of the second electrode unit is less than a distance between neighbor pixel electrodes.

3. The display apparatus according to claim 1, wherein the liquid crystal unit includes:
a plurality of liquid crystal unit capsules having liquid crystal unit molecules aligned according to the electric field; and
a matrix configured to accommodate the plurality of liquid crystal unit capsules where the plurality of pixel electrodes are spaced apart from each other by a predetermined distance.

4. The display apparatus according to claim 3, wherein:
when the electric field is formed in the liquid crystal unit, the liquid crystal unit molecules of the liquid crystal unit are arranged parallel to a surface of the display panel in a peripheral part of the plurality of pixel electrodes.

5. The display apparatus according to claim 3, wherein the height of the liquid crystal unit exceeds a half a ratio of a wavelength of light incident upon the liquid crystal unit to a bi-refraction value of the liquid crystal unit molecules.

6. The display apparatus according to claim 1, wherein the display panel further includes:
a color filter arranged adjacent to the first electrode unit; and
a substrate arranged adjacent to the color filter.

7. The display apparatus according to claim 1, wherein the display panel further includes:
a first polarization panel configured to transmit light of a first polarization axis from among light emitted from the backlight unit; and
a second polarization panel having a second polarization axis perpendicular to the first polarization axis, and configured to transmit light of the second polarization axis from among light having passed through the liquid crystal unit.

8. The display apparatus according to claim 7, wherein the display panel further includes:
a protective panel disposed between the second polarization panel and the liquid crystal unit to protect the liquid crystal unit.

9. The display apparatus according to claim 1, wherein:
the height of the liquid crystal unit is identical to the height between the insulator and the protective panel.

10. The display apparatus according to claim 1, wherein:
the plurality of pixel electrodes of the second electrode unit is formed in a three-dimensional (3D) structure protruding from the insulator toward the liquid crystal unit; and
a cross-sectional shape of the three-dimensional (3D) structure is one of a square shape, a triangular shape, a semi-circular shape, and an oval shape.

11. A display apparatus having a backlight unit and a display panel, comprising:
the display panel comprising:
a first electrode unit having a common electrode;
a second electrode unit having a different polarity from the first electrode unit, and configured to include a plurality of pixel electrodes each forming an electric field using an electric force of the first electrode unit;
an insulator disposed between the first electrode unit and the second electrode unit to achieve electric insulation between the first electrode unit and the second electrode unit; and
a liquid crystal unit configured to include not only a plurality of liquid crystal unit capsules, but also a matrix including the plurality of liquid crystal unit capsules and the second electrode unit,
wherein a height of the plurality of pixel electrodes of the second electrode unit is equal to or greater than ⅓ of the height of the liquid crystal unit; and
a width of each pixel electrode of the second electrode unit is less than a distance between neighbor pixel electrodes.

12. The display apparatus according to claim 11, wherein the liquid crystal unit is arranged to contact the second electrode unit and the insulator.

13. The display apparatus according to claim 11, wherein:
when the electric field is formed in the liquid crystal unit, the liquid crystal unit molecules contained in a liquid crystal unit capsule of the liquid crystal unit are arranged parallel to a surface of the display panel in a peripheral region of the plurality of pixel electrodes.

14. The display apparatus according to claim 11, wherein the first electrode unit and the second electrode unit are configured to receive electric signals having different polarities.

15. The display apparatus according to claim 11, wherein:
the plurality of pixel electrodes of the second electrode unit is formed in a protruding three-dimensional (3D) structure; and
a cross-sectional shape of the three-dimensional (3D) structure includes one of a square shape, a triangular shape, a semi-circular shape, and an oval shape.

16. A display panel comprising:
a common electrode;
pixel electrodes having a different polarity from the common electrode and each forming an electric field;
an insulator disposed between the common electrode and the pixel electrodes; and
a liquid crystal matrix including liquid crystal capsules and the pixel electrodes and having a height,
wherein a pixel electrode height being greater than or equal to ⅓ the height of the matrix and a width of each pixel electrode being less than a distance between neighbor pixel electrodes allowing electric flux of the field generated in a vicinity of a pixel electrode to be generated parallel to a surface of the display panel and allowing the electric flux parallel to a peripheral part of the pixel electrode to have a predetermined height improving light brightness of the display panel.

17. A method of forming a display panel, comprising:
providing a common electrode;
providing pixel electrodes each forming an electric field and having a different polarity from the common electrode;
disposing an insulator between the common electrode and the pixel electrodes; and
disposing a matrix of liquid crystal capsules with the pixel electrodes,
wherein a pixel electrode height being greater than or equal to ⅓ the height of the matrix and a width of each pixel electrode of the pixel electrodes being less than a distance between neighbor pixel electrodes allowing electric flux of the field generated in a vicinity of a pixel electrode to be generated parallel to a surface of the display panel and allowing the electric flux parallel to a peripheral part of the pixel electrode to have a predetermined height improving light brightness of the display panel.

18. A method of forming a display panel, comprising:
stacking an insulator on a common electrode;
forming pixel electrodes on the insulator, each of the pixel electrodes producing an electric field and having a different polarity from the common electrode; and
coating a matrix of liquid crystal capsules with the pixel electrodes on the insulator and over the pixel electrodes,
wherein a pixel electrode height being greater than or equal to ⅓ the height of the matrix and a width of each pixel electrode of the pixel electrodes being less than a distance between neighbor pixel electrodes allowing electric flux of the field generated in a vicinity of a pixel electrode to be generated parallel to a surface of the display panel and allowing the electric flux parallel to a peripheral part of the pixel electrode to have a predetermined height improving light brightness of the display panel.
